(19) United States
(12) Patent Application Publication
(10) Pub. No.: US 2004/0193467 A1
(43) Pub. Date: Sep. 30, 2004

(54) Statistical analysis and control of preventive maintenance procedures

(75) Inventors: Thomas P. Williams, Hastings, MN (US); John W. McRell, Woodbury, MN (US); Martha J. Tateosian, Shoreview, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/403,330

(22) Filed: Mar. 31, 2003

(51) Int. Cl. G06F 17/60

(52) U.S. Cl. 705/8

(57) ABSTRACT

Techniques are described for determining the effectiveness of preventive maintenance procedures in detecting and reducing equipment failures. The techniques make use of historical maintenance data, e.g., maintenance data from a computerized maintenance management system (CMMS), that identifies the preventive maintenance procedures, as well as unplanned maintenance procedures for repairing the equipment. The techniques are used to statistically analyze the maintenance data to determine whether a statistical correlation exists between the preventive and unplanned maintenance procedures. In particular, the techniques correlate any failures experienced by that equipment, as serviced by the unplanned maintenance procedures, to the preventive maintenance procedures that were designed to detect or eliminate those failures. Based on the analysis, an effectiveness of each preventive maintenance activity can be determined, and a respective frequency of each preventive maintenance activity can be statistically controlled.

### TECHNICAL FIELD

The invention relates to scheduling preventive maintenance procedures for equipment.

### BACKGROUND

A variety of maintenance procedures are typically performed on operating equipment. For example, in the event of a failure or other event or condition that causes the equipment to operate in an unintended manner, a technician may be called to perform a maintenance procedure in an attempt to repair the equipment. This type of unplanned procedure is commonly referred to as an emergency or corrective maintenance procedure.

In addition, preventive maintenance procedures are often performed on equipment in accordance with a maintenance schedule. These procedures are performed with the goal of reducing the likelihood of future failure of the machine, thereby reducing costs, resources, and general “down-time” associated with those failures.

In many situations, preventive maintenance procedures are performed in accordance with a static maintenance plan. For example, a typical maintenance plan schedules preventive maintenance procedures in accordance with a maintenance frequency, e.g., weekly or monthly, after a fixed number of operational hours, production units, and the like. Often, a computerized maintenance management system (CMMS) or other utility is used to schedule the preventive maintenance procedures based on the prescribed frequencies, as well as log and track maintenance activities performed on the equipment.

### SUMMARY

In general, the invention is directed to statistical analysis techniques for determining the effectiveness of preventive maintenance (PM) procedures in detecting and reducing equipment failures. The techniques make use of historical data, e.g., maintenance data collected from a computerized maintenance management system (CMMS), that identifies the preventive maintenance procedures and the unplanned maintenance procedures performed on any type of machine, device, component, and the like, which is generally referred to herein as “equipment.”

The techniques are used to statistically analyze the preventive maintenance procedures and the unplanned maintenance procedures performed on the equipment during a period, such as one year, and attempt to identify any statistical correlation between the preventive maintenance procedures and the unplanned maintenance procedures. In particular, the techniques correlate any failures experienced by that equipment, as serviced by the unplanned maintenance procedures, to the preventive maintenance procedures that were designed to detect or eliminate those failures. Based on the analysis, an effectiveness of each preventive maintenance activity can be determined, and a respective frequency of each preventive maintenance activity can be statistically controlled.

In one embodiment, the invention is directed to a method comprising analyzing maintenance data to identify preventive maintenance procedures and unplanned maintenance procedures performed on equipment, and mapping the unplanned maintenance procedures to identifiers associated with the preventive maintenance procedures. The method further comprises determining whether statistical correlations exist between the preventive maintenance procedures and the unplanned maintenance procedures based on the mapping, and updating frequencies for the preventive maintenance procedures based on the determination.

In another embodiment, a method comprises statistically analyzing maintenance data that specifies preventive maintenance procedures and unplanned maintenance procedures performed on equipment to generate one or more correlation equations. The method further comprises computing frequencies for the preventive maintenance procedures using the correlation equations, and performing the preventive maintenance procedures on the equipment in accordance with the computed frequencies.

In another embodiment, a method comprises presenting an interface to receive maintenance data that defines shop work orders for preventive maintenance procedures and unplanned maintenance procedures for equipment, wherein the interface includes an input area to map the shop work orders to identifiers associated with the preventive maintenance procedure. The method further comprises automatically analyzing the maintenance data in accordance with the mapping to determine whether statistical correlations exist between the preventive maintenance procedures and the unplanned maintenance procedures, and automatically updating frequencies associated with the preventive maintenance procedures based on the determination.

In another embodiment, the invention is directed to a system comprising a database, a scheduler and a statistical analysis module. The database stores maintenance data that describes preventive maintenance procedures and unplanned maintenance procedures performed on equipment. The scheduler generates a schedule for the preventive maintenance procedures in accordance with respective frequencies, and the statistical analysis module analyzes the maintenance data and computes updated frequencies for the preventive maintenance procedures based on statistical correlations between the preventive maintenance procedures and the unplanned maintenance procedures.

In another embodiment, the invention is directed to a computer-readable medium containing instructions. The instructions cause a programmable processor to present an interface to receive maintenance data that define shop work orders for preventive maintenance procedures and unplanned maintenance procedures for equipment, wherein the interface includes an input area to map the shop work orders to identifiers associated with the preventive maintenance procedure. The instructions further cause the processor to automatically analyze the maintenance data in accordance with the mapping to determine whether statistical correlations exist between the preventive maintenance procedures and the unplanned maintenance procedures, and automatically update frequencies associated with the preventive maintenance procedures based on the determination.

The techniques described herein may offer one or more advantages. For example, by correlating any failures experienced by the equipment to the preventive maintenance procedures that were designed to detect or eliminate those failures, the techniques may be used to statistically measure the effectiveness of each preventive maintenance activity. Based on this statistical measurement, the frequencies of the preventive maintenance procedures can be controlled.

As a result, the techniques may be used to identify potential opportunities for improvement to the frequencies of the preventive maintenance procedures by aiding in the determination of whether any of the PM procedures have been conducted too frequently, too infrequently or with inconsistent intervals. Moreover, the techniques may aid in identifying any of the PM procedures that have been conducted improperly, thus leading to equipment failures.

The details of one or more embodiments of the invention are set forth in the accompanying drawings and the description below. Other features, objects and advantages of the invention will be apparent from the description and drawings, and from the claims.

### BRIEF DESCRIPTION OF DRAWINGS

FIG. 1 is a block diagram of an exemplary system that illustrates techniques for statistically controlling frequencies of preventive maintenance (PM) procedures.

FIG. 2 is a flowchart illustrating an overview of the techniques in analyzing historical maintenance data to statistically control frequencies of PM procedures.

FIG. 3 is a flowchart illustrating the statistical analysis techniques in further detail.

FIG. 4 illustrates an example Pareto chart that illustrates exemplary failure frequencies for a given PM code.

FIG. 5 is an example chart that illustrates exemplary mean actual labor cost for failures associated with a PM code.

FIG. 6 illustrates an example interface that illustrates computation of exemplary actual frequencies at which the PM procedures were executed, and a number of failures between each PM associated with a given PM code.

FIG. 7 is an exemplary chart that graphs frequencies and confidence levels for PM procedures for a PM code.

FIG. 8 is a chart showing an exemplary regression analysis.

FIG. 9 is a chart that graphs mean time between failures for a particular failure type at 95% confidence levels.

FIG. 10 illustrates an exemplary control chart that graphs actual repair hours, mean repair hours, and confidence levels for emergency type shop work orders.

FIG. 11 is a flow chart illustrating in further detail an exemplary process of controlling the PM frequencies based on computed statistical data.

FIG. 12 is a block diagram in which a computer maintenance management system employs the techniques to statistically control frequencies of PM procedures in an automated fashion.

### DETAILED DESCRIPTION

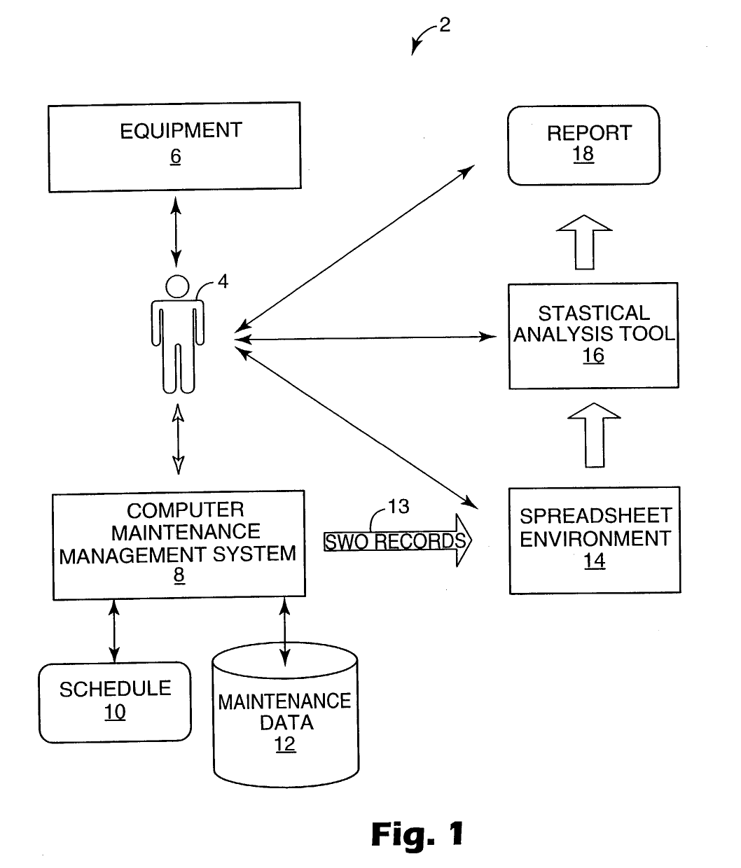

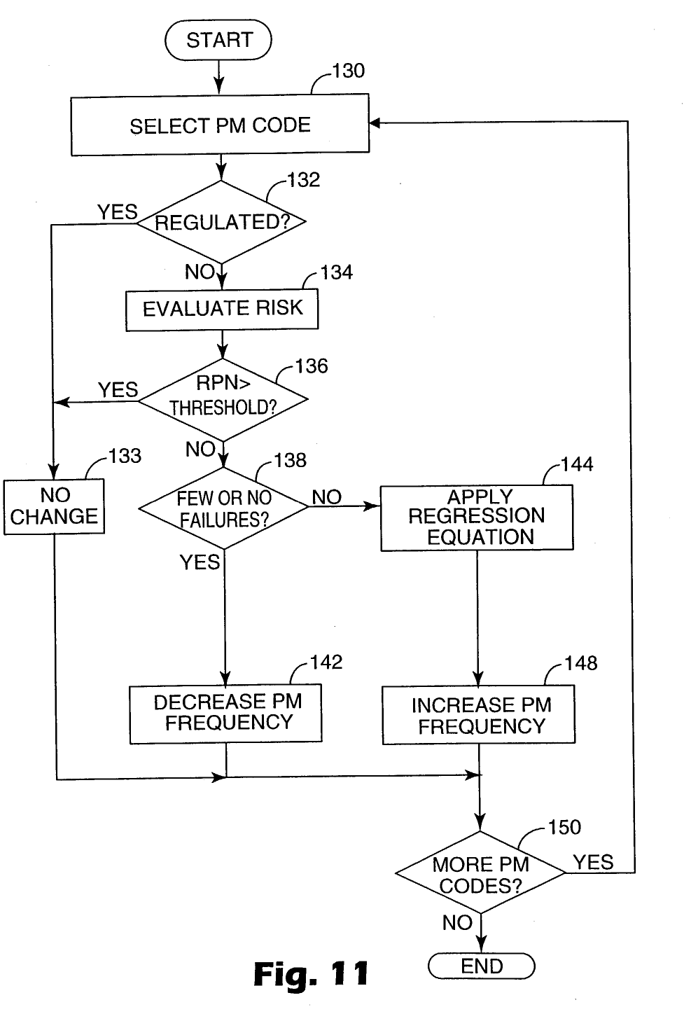

FIG. 1 is a block diagram of an exemplary system 2 that illustrates techniques for statistically controlling frequencies of preventive maintenance (PM) procedures. In particular, FIG. 1 illustrates an embodiment in which the techniques are implemented in a manual or semi-automated manner. As described below in reference to FIG. 11, the techniques may also be implemented in an automated fashion requiring reduced involvement of a user, e.g., technician 4.

In the illustrated embodiment, a technician 4 provides maintenance services for equipment 6. In general, the term “equipment” as used herein refers to any component, machine, device, apparatus, and the like, that requires maintenance services. Moreover, although described for exemplary purposes in reference to a single technician 4, one or more operators, technicians, data entry clerks, managers, users, and the like may perform the operations described herein in reference to technician 4.

Technician 4 provides unplanned maintenance procedures, such as corrective or emergency maintenance procedures, in the event of a failure of equipment 6. In addition, technician 4 performs PM procedures in accordance with a schedule 10 maintained by a computerized maintenance management system (CMMS) 8. Schedule 10 defines a set of PM procedures to be performed on equipment 6. Each PM procedure may be defined to include one or more PM activities. CMMS 8 maintains schedule 10 to provide due dates for PM procedures based on defined frequencies for performing the PM procedures. For example, a PM procedure may be performed periodically, e.g., weekly or monthly, or after a fixed number of operational hours, production units produced by equipment 6, and the like. An example of a computerized maintenance management system is Maximo™ marketed by MRO Software, Inc. of Bedford Mass.

In addition, technician 4 interacts with CMMS 8 to log and track maintenance procedures performed on an operating machine. In particular, CMMS 8 maintains maintenance data 12 that describes pending and completed shop work orders (SWOs) for equipment 10. For example, for each SWO, maintenance data 12 defines an SWO record that may describe an equipment number identifying the particular equipment serviced, e.g., equipment 6, as well as a SWO number, a starting date for the SWO, a problem description, and a work order type, such as emergency maintenance (EM), corrective maintenance (CM), or preventive maintenance (PM). In addition, maintenance data 12 may define an estimated labor and material cost, and an actual labor and material cost for each SWO. CMMS 6 may maintain maintenance data 12 in a “database” that may take the form of any of a variety of data structures, including one or more files, a relational database, an object-oriented database, and the like.

In accordance with an embodiment of the invention, technician 4 interacts with CMMS 8 to extract or otherwise export all or a portion of the SWO records maintained by maintenance data 12 for a previous period, e.g., one year. The extracted SWO records 13 describe the SWOs initiated and performed over the period. In particular, the extracted SWO records 13 describe the non-planned maintenance procedures, e.g., EM and CM procedures, as well as each PM procedure performed.

As illustrated in FIG. 1, technician 4 may export SWO records 13 to a spreadsheet environment 14 for pre-processing and initial analysis. In addition, technician 4 may utilize a statistical analysis tool 16 to further analyze SWO records 13. One example of a spreadsheet environment 14 is Microsoft™ Excel marketed by Microsoft Corporation of Redmond, Wash. An example of a statistical analysis tool is Minitab™ marketed by Minitab, Inc. of State College, Pa.

In general, technician 4 employs statistical analysis techniques described herein to analyze SWO records 13, and determine an effectiveness of the PM procedures in detecting and reducing failures of equipment 6. More specifically, the techniques process the SWO records 13 to statistically analyze the planned and unplanned maintenance procedures performed on equipment 6, and produce an analysis report 18 that identifies any correlation between the planned and unplanned maintenance procedures. In particular, the techniques correlate any failures experienced by that equipment 6, as serviced by the unplanned maintenance procedures, to the preventive maintenance procedures that were designed to detect or eliminate those failures.

Based on the analysis report 18, technician 4 is able to assess the effectiveness of each PM activity. Based on such assessments, technician 4 interacts with CMMS 8 to control the frequencies of each PM procedure. For example, for those PM procedures having a degree of correlation with failures, as indicated by analysis report 18, technician 4 may elect to increase frequencies associated with those PM procedures. For those PM procedures for which no correlation is identified, i.e., procedures for which few or no associated failures occurred, technician 4 may elect to decrease the associated frequencies. In these situations, costs associated with labor and materials for these PM procedures may have been spent with little or no benefit in return. In this manner, the techniques allow for statistical control over the frequencies of the PM procedures.

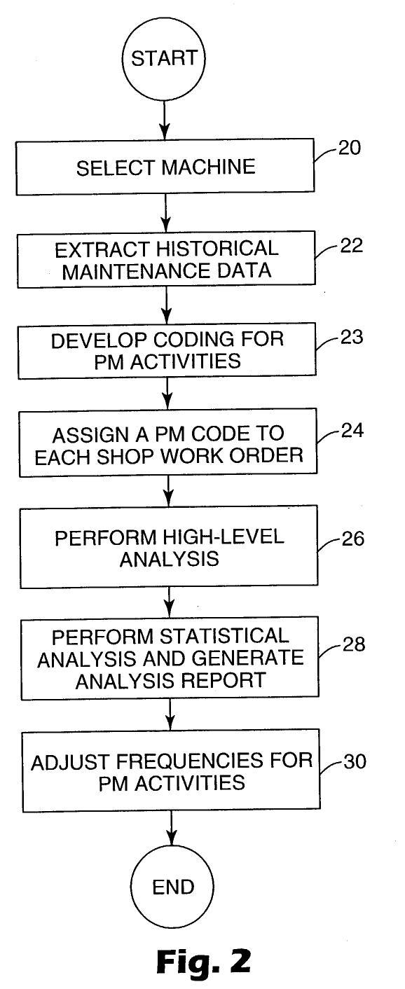

FIG. 2 is a flowchart illustrating an overview of the techniques in analyzing historical maintenance data to statistically control PM frequencies. Initially, technician 4 selects equipment 6 for analysis (20). For example, if an organization has multiple machines or other pieces of equipment that receive PM services, technician 4 may select the equipment 6 to analyze based on a number of criteria, such as total maintenance costs per equipment, ratio of PM SWOs to emergency or corrective SWOs, production throughput, and the like.

Next, technician 4 interacts with CMMS 8 to extract SWO records 13 for a previous period of time (22). As described, the extracted SWO records 13 describe the non-planned maintenance procedures, e.g., EM and CM procedures, as well as each PM procedure performed during the period. As illustrated in FIG. 1, technician 4 may export SWO records 13 to a spreadsheet environment 14 for pre-processing and initial analysis.

Upon extracting SWO records 13, technician 4 generates a coding scheme that assigns unique identification codes, referred to as “PM codes,” to each of the defined PM procedures performed on equipment 6 (23). As described, each PM procedure specified by a SWO may have required the performance of one or more PM activities. For example, a PM procedure performed in response to a SWO may be viewed as a set of PM activities performed on one or more components of equipment 6. During this process, PM codes may be designated in any manner that supports correlation of failures to PM procedures or activities designed to detect, prevent or eliminate those failures.

The following Table 1 is an example of a PM coding for a relatively simple machine. In this example, the PM codes are identified for each PM procedure component on the machine. In other words, the “granularity” of the mapping may be viewed as relatively high-level in that PM codes are assigned to different PM procedures performed on different components.

TABLE 1

| PM PROCEDURE | PM CODE | PM ACTIVITY OR FOCUS |
|---|---|---|
| PMLC7WO1 | 1 | Pneumatics |
| PMLC7WO1 | 2 | Cooling |
| PMLC7WO1 | 3 | Loader/Unloader |
| PMLC7MO1 | 4 | Machine Leveling |
| PMLC7Q0 1 | 5 | Pumps |
| PMLC7MO1 | 6 | Cameras |
| PMLC7MO1 | 7 | Gearbox/Indexer |
| PMLC7SA1 | 8 | Laser |
| PMLC7QO1 | 9 | Gas/Air Filters |
| N/A | 10 | Miscellaneous |

The following Table 2 is an example of a PM activity coding for more complex machinery. As illustrated in the next example, PM codes can be mapped to provide a more granular mapping to PM procedures, the equipment components addressed by each PM procedure, and the specific PM activities conducted by the procedures. Other mappings of the PM codes that logically support correlation of PM procedures or individual activities to failure modes may be used in accordance with the techniques described herein.

TABLE 2

| EQUIPMENT | PM | | PM |
|---|---|---|---|
| COMPONENTS | PROCEDURE | ACTIVITY | CODE |
| 918000 Slitter | SD964000 | Safety Device | 1 |
| | SP956015 | E-Stops | 2 |
| | IR708036 | IR Survey | 3 |
| | OE918000 | Overhaul | 4 |
| | TP754140 | Machine | 5 |
| | | Inspection | |
| | LB754129 | Lubrication | 6 |
| | IN000028 | Calibration | 7 |
| | TP786011 | Back Up's | 8 |
| 968000 L Cartoner | SD964000 | Safety Device | 1 |
| | IR708036 | IR Survey | 3 |
| | OH968000 | Overhaul | 9 |
| | TP754103 | Machine | 10 |
| | | Inspection | |
| | TP786021 | Back Up's | 11 |
| | LB754127 | Lubrication | 12 |
| 968044 ME Overwrapper | IR708036 | IR Survey | 3 |
| | OH968044 | Overhaul | 13 |
| | TP786024 | Back Up's | 14 |
| | TP754104 | Machine | 15 |
| | | Inspection | |
| | LB754128 | Lubrication | 16 |
| 968066 HS Labeler | IR708036 | IR Survey | 3 |
| | TP754159 | Machine | 17 |
| | | Inspection | |
| | OH968066 | Overhaul | 18 |
| 968072 LC Packer | SD956013 | Safety Device | 19 |
| | OH968072 | Overhaul | 20 |
| | IR708036 | IR Survey | 3 |
| | TP754106 | Machine | 21 |
| | | Inspection | |
| | TP786019 | Back Up's | 22 |
| | LB754126 | Lubrication | 23 |
| 968076 Palletizer | IR708036 | IR Survey | 3 |
| | OH968076 | Overhaul | 24 |
| | TP754130 | Machine | 25 |
| | | Inspection | |
| | LB786015 | Lubrication | 26 |
| 968077 Pallet Lifts | OH968077 | Overhaul | 27 |
| 968078 Accumulation | OH968078 | Overhaul | 28 |
| Conveyor | | | |
| 968080 Line Conveyor | | Line conveyor | 29 |
| 918051 Unwind | | Unwind | 30 |
| Change Over | | Change Over | 40 |
| Miscellaneous | | Miscellaneous | 50 |
| Production PM's | | Production PM's | 60 |

In both of the above example coding schemes, the PM code of “Miscellaneous” was created to facilitate the identification and analysis of failure modes that do not have preventive or predictive procedures written to detect or eliminate the failure mode.

Once the coding scheme has been developed, technician 4 reviews each SWO with respect to the PM coding scheme as established above, and assigns a respective PM code to each of the SWOs (24). For each emergency and corrective SWO, for example, technician 4 assigns a PM code (24) designed to detect or eliminate the serviced equipment failure.

Next, spreadsheet environment 14 may be invoked to perform initial high-level analysis of the coded historical data (26). For example, spreadsheet environment 14 allows the data to be sorted, filtered and even color-coded to assist in the identification of trends, e.g., patterns in inconsistent PM frequencies contributing to increased failures, patterns of increased failures between PM procedures, patterns of few or no failures between PM procedures, patterns of failures after completion of a PM procedure. The coded historical data can easily be manipulated to identify potential opportunities for improvement to the PM procedures. For example, the coded data provides indicators for any of the PM procedures or activities that have been conducted too frequently, too infrequently or at inconsistent intervals. In addition, the coded and processed data may also reveal situations where PM procedures have not been conducted properly. For example, failures that occurred immediately after PM procedures to which the failures are mapped may be an indication that the PM procedures were improperly performed. The results of this initial analysis are used as initial indicators of opportunities for modification to the PM frequencies and identify candidates for further statistical evaluation.

After completing the high-level analysis (26), statistical analysis tool 16 may be invoked to statistically analyze the coded data, as described in further detail below. Based on the analysis, statistical analysis tool 16 produces analysis report 18. Analysis report 18 identifies any statistical correlation between the PM procedures and the failures experienced by equipment 6 (28). Based on analysis report 18, technician 4 is able to assess the effectiveness of each PM activity, and interacts with CMMS 8 to control the frequencies of each PM procedure (30). This process may be repeated, e.g., daily, weekly, monthly, or annually, to achieve statistical control over the frequencies of the PM procedures.

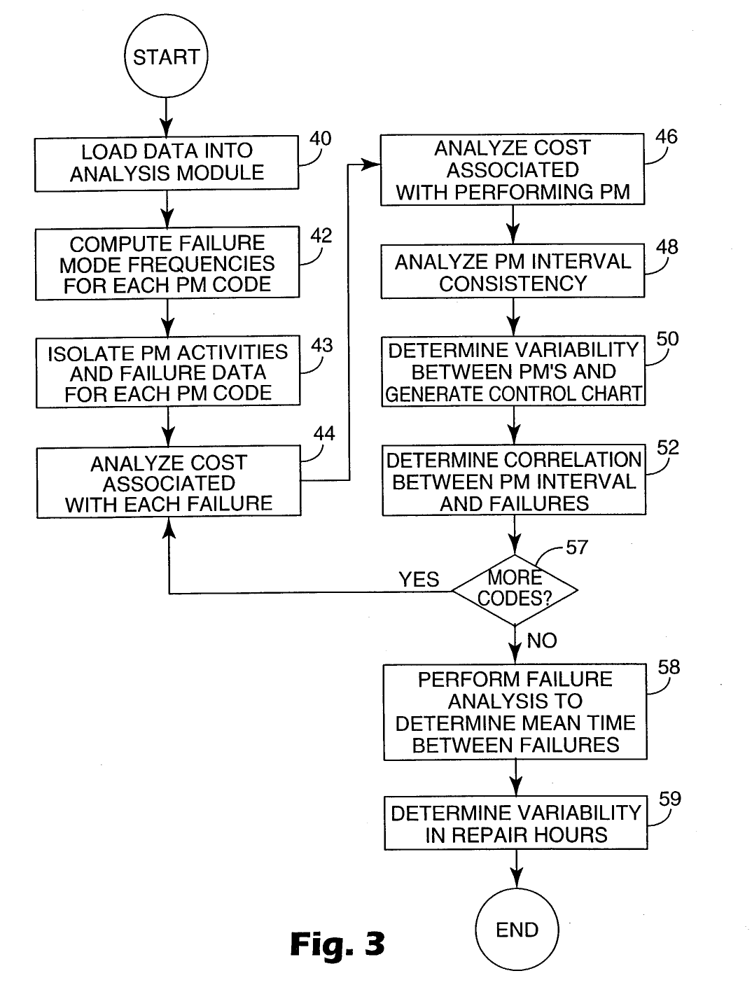

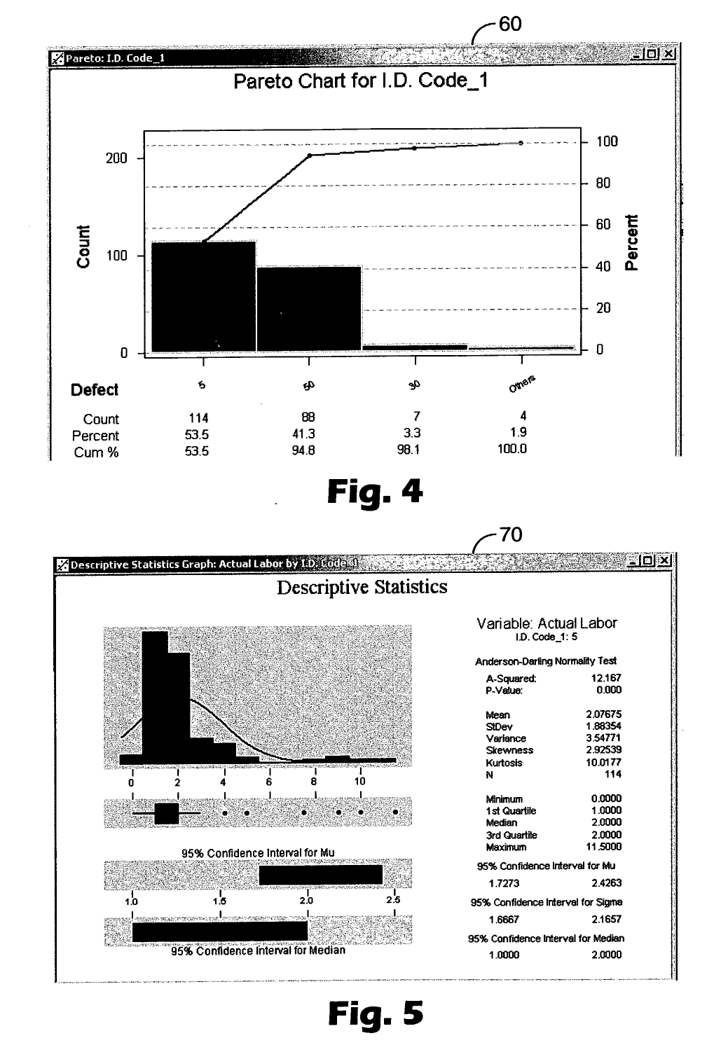

FIG. 3 is a flowchart illustrating in further detail the statistical analysis techniques employed by statistical analysis tool 16 in identifying any statistical correlation between the PM procedures and the failures experienced by equipment 6. Initially, the coded data is loaded into statistical analysis tool 16 (40). For exemplary purposes, the flowchart of FIG. 3 is described in reference to FIGS. 4-9, which illustrate example charts and user input screens presented by statistical analysis tool 16.

Initially, statistical analysis tool 16 computes frequencies for each failure associated with each PM code. In one embodiment, statistical analysis tool 16 generates Pareto charts that illustrate failure counts for each PM code. This data is subsequently used for prioritization during analysis of the individual PM codes and associated failures. FIG. 4 illustrates an example Pareto chart 60 that illustrates exemplary failure frequencies for equipment being analyzed. In this example, Pareto chart 60 illustrates that 53%, 43.1%, and 3.3% of the failures are associated with failure types mapped to PM codes 5, 50, and 30, respectively.

Referring again to the flowchart of FIG. 3, upon determining the frequency of failures, data for PM procedures and failure data is isolated for each PM code (43). For example, this may be accomplished by first creating separate analysis environments, e.g., worksheets, with statistical analysis tool 16. Next, the coded data and computed failure data may be sorted based on PM codes. Portions of the sorted data may then be copied to the respective analysis environments based on the PM codes.

Once the data is isolated by PM code, statistical analysis tool 16 is invoked to perform a variety of statistical analysis functions on the isolated portions. For example, statistical analysis tool 16 analyzes the isolated data to provide technician 4 with an understanding of the average labor cost, material cost, or both, per failure for a particular PM code (44).

FIG. 5 is an example chart 70 produced by statistical analysis tool 16 that illustrates exemplary mean actual labor cost for failures associated with a PM code 5. Similarly, statistical analysis tool 16 analyzes the cost associated with conducting each PM procedure or activity mapped to a particular PM code to provide technician 4 with an understanding of the average labor, material, or both expended to conduct the PM procedure or activity (46).

Statistical analysis tool 16 then analyzes the consistency of the actual PM frequencies by determining a mean time between PM procedures or activities mapped to a particular PM code (48). The analysis is useful in assessing the consistency at which the PM procedure or activity mapped to the PM code was performed in view of the designed frequency of the PM. In addition, the analysis may be useful in determining whether any variability of PM interval has had any effect on the failures experienced by equipment 6. Specifically, the number of failures listed between each performed PM procedure is tabulated. In addition, dates associated with the PM procedures are used to determine a mean time between PM's.

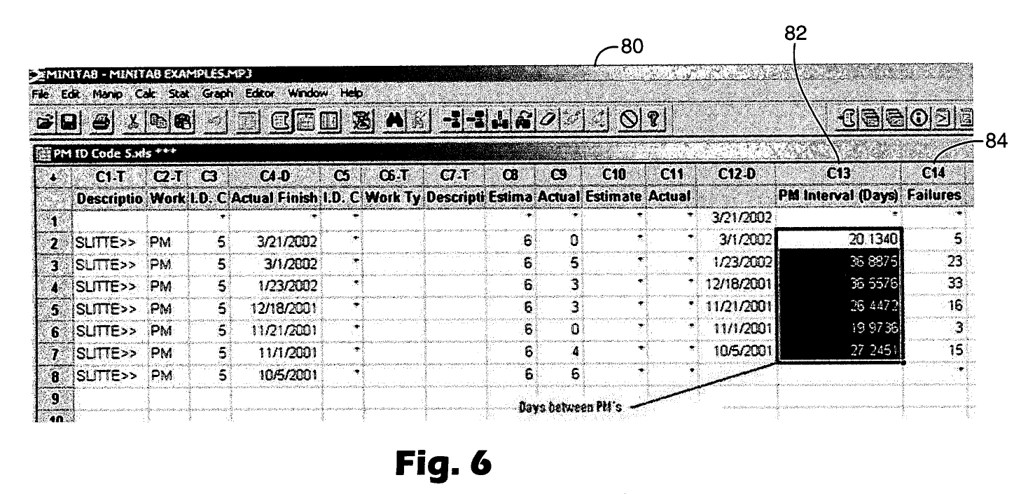

FIG. 6 illustrates an example interface 80 presented by statistical analysis tool 16 that illustrates computation of exemplary actual frequencies 82 at which the PM procedures were executed, and a number of failures 84 between each PM associated with PM code 5.

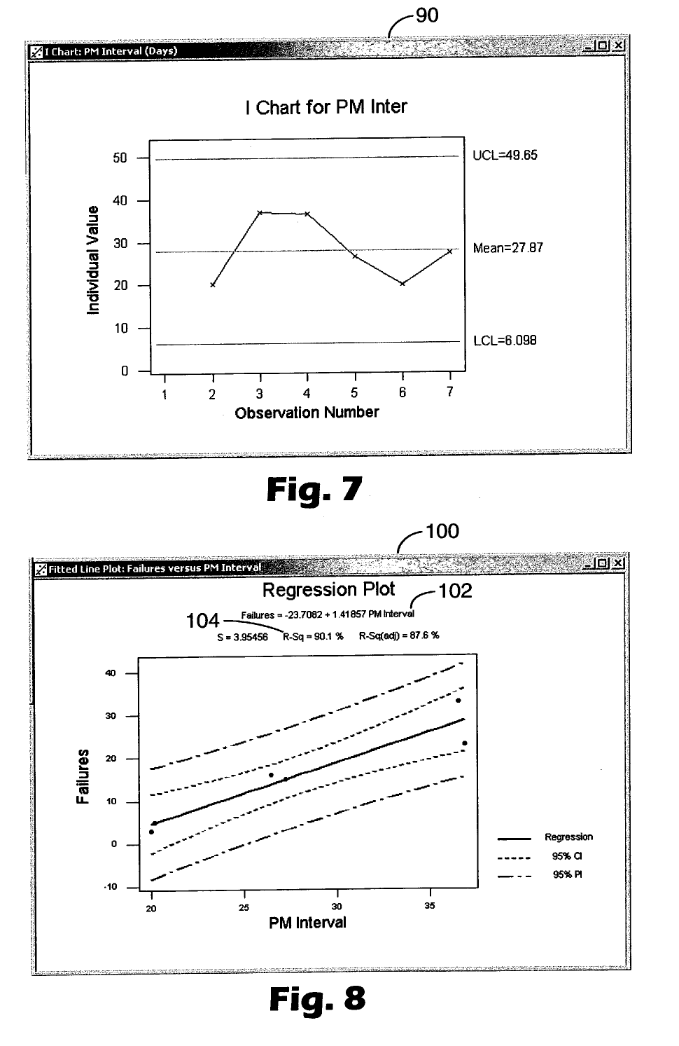

Next, statistical analysis tool 16 analyzes the computed frequencies to determine any statistical variability for the computed frequencies of the PM procedures or activities for the particular PM code (50). Based on the statistical variability, statistical analysis tool 16 then generates a statistical control chart for the PM frequency variability. This chart also provides the mean frequency that the PM was executed, which may be subsequently used to identify and calculate frequency adjustments. FIG. 7 is an exemplary chart 90 that graphs frequencies and control limits for PM procedures for PM code 5.

Based on the computed variability, statistical analysis tool 16 performs a regression analysis to assist in determination of whether a correlation exists between PM interval and the number of equipment failures that occur between procedures or activities (52). When the regression analysis demonstrates a strong correlation between the PM frequency and the number of failures that occur between the PM procedures or activities, the techniques can be used to statistically control the PM frequency. FIG. 8 illustrates a chart 100 showing an exemplary regression analysis generated by statistical analysis tool 16.

After performing the regression analysis, statistical analysis tool 16 repeats the analytical process on the data for each PM code (57). In this manner, portions of the coded data may be separately processed for each PM code, as described above, for use in determining for each PM code whether a correlation exists between the PM interval for procedures or activities associated with that PM interval, and the number of equipment failures that occur between procedures or activities.

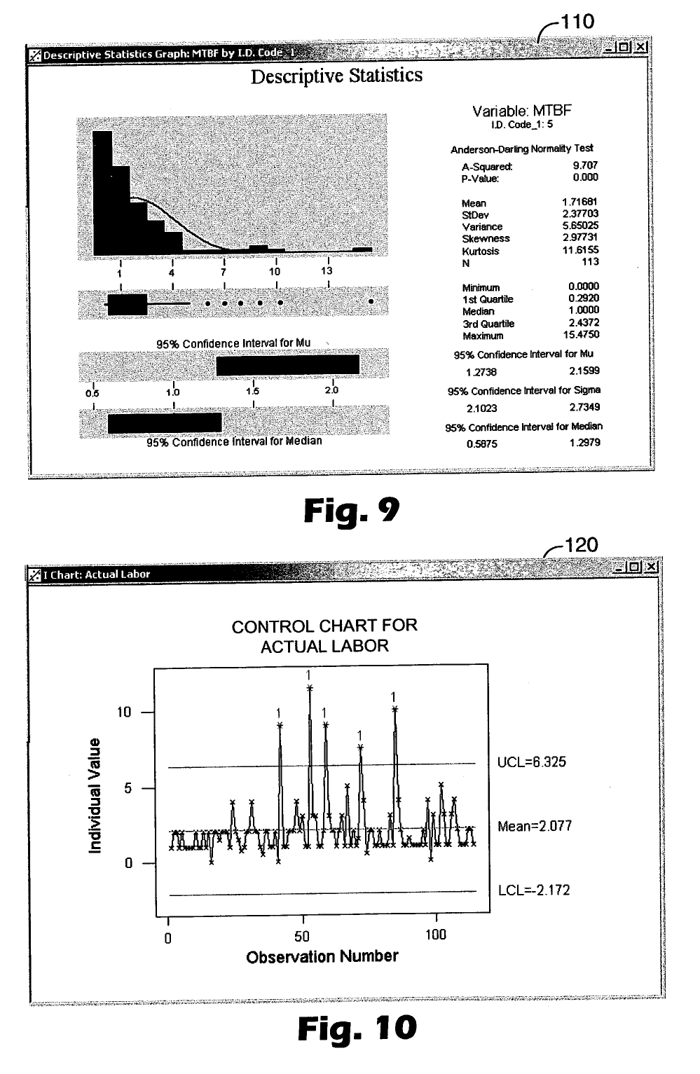

After separately analyzing the isolated data associated with each PM code, statistical analysis tool 16 performs a failure analysis across all of the data without regard to particular PM codes. For example, statistical analysis tool 16 analyzes the data to determine a mean time between failures for the types of failures experienced by equipment 6 (58). For example, FIG. 9 illustrates a chart 110 that graphs mean time between failures for a particular failure type at 95% confidence levels.

Finally, statistical analysis tool 16 determines the variability in repair hours for emergency type SWOs (59). This analysis may be useful to technician in predicting a worst case downtime for equipment 6. For example, FIG. 10 illustrates an exemplary control chart 120 that graphs actual repair hours, mean repair hours, and control limits for emergency type SWOs for equipment 6.

FIG. 11 is a flow chart illustrating in further detail an exemplary process of controlling the PM frequencies based on the statistical data produced by statistical analysis tool 16. Initially, one of the PM codes is selected (130), and a determination is made as to whether the frequency associated with the PM code is regulated, such as by a government agency (132).

If the frequency is regulated, then no change is made to the frequency (133). Otherwise, a risk evaluation process is employed to evaluate a level of risk that may be associated with the related failure code, and may be caused by a modification to the frequency associated with the PM code (134). More particularly, a Risk Priority Number (RPN) is calculated in accordance with the following equation:

RPN=Severity*Occurrence*Detection. (1)

In Equation 1, an RPN value is calculated based on a severity rating, an occurrence rating, and a detection rating. The severity rating represents a rating for the severity of any potential injury or harm that may result from the associated failure, and may be defined by ranges as indicated in Table 3 below:

TABLE 3
Severity Rating

| | |
|---|---|
| 10 = Dangerously High | Failure could cause injury. |
| 9 = Extremely High | Failure would create EHS&R non-compliance |
| 8 = Very High | Failure renders unit inoperable |
| 7 = High | Failure causes customer dissatisfaction |
| 6 = Moderate | Failure results in partial malfunction |
| 5 = Low | Failure creates performance loss/complaints |
| 4 = Very Low | Failure can be bypassed, minor performance |
| | loss |
| 3 = Minor | Failure creates nuisance, no performance loss |
| 2 = Very Minor | Failure is readily apparent, minor process |
| | detect |
| 1 = None | Failure does not affect process or product |

The occurrence rating represents a rating for a frequency that the failure may occur, and may be defined by ranges as indicated in Table 4 below:

TABLE 4
Occurrence Rating

| | | General | Production |
|---|---|---|---|
| 10 = Very High (Inevitable) | One occurrence | per day | per shift |
| 9 = High (Often as not) | One occurrence | per 3 to 4 days | per day |
| 8 = High (Repeatedly) | One occurrence | per week | per 1-3 days |
| 7 = High (Often) | One occurrence | per month | per 3-5 days |
| 6 = Moderately High | One occurrence | per 3 months | per week |
| 5 = Moderate | One occurrence | per 3-6 months | per 1-2 wks |
| 4 = Moderately Low | One occurrence | per year | per 2-4 wks |
| 3 = Low | One occurrence | per 1-3 years | per 1-3 months |
| 2 = Low (Few/far between) | One occurrence | per 3-5 years | per 3-6 months |
| 1 = Remote | One occurrence | per 5+ years | per 6-12 months |

The detection rating represents a rating for the likelihood of detecting the failure in the event the failure occurs, and may be defined by ranges as indicated in Table 5 below:

TABLE 5
Detection Rating

| | |
|---|---|
| 10 = Absolute Uncertainty | Hidden failure, not predictable |
| 9 = Very Remote | Hidden failure, 2^{ND} failure to uncover |
| 8 = Remote | Detectable from reaction to input |
| 7 = Very Low | Defect noted from 100% product/process |
| | checks |
| 6 = Low | Defect noted from random product checks |
| 5 = Moderate | Defect noted from random process checks |
| 4 = Moderately High | Defect is detectable by inspection |
| 3 = High | Defect is detectable by remote measurement |
| 2 = Very High | Defect noted with on line measurement |
| 1 = Almost Certain | Defect noted with on line process |
| | monitoring/alarms |

If the RPN value exceeds a threshold (136), then no change is made to the PM frequency as the risks are too great (133). Otherwise, a determination is made as to whether few or no failures have occurred between PM procedures or activities mapped to that particular PM code (138).

If less than a threshold number of failures have occurred, e.g., few or none, these PM procedures or activities are considered prime candidates for a decrease in PM frequencies, i.e., an increase to the interval between PM procedures or activities, as resources may have been expended for little or no return. If the evaluations indicate the opportunity to decrease the PM frequency associated with the PM code can be accomplished within an acceptable risk, e.g., below the threshold, the PM frequency is decreased (142). The frequency decrease may be based on a vendor supplied MTBF, if available, or as a function of the RPN value and the current frequency, as indicated in Table 6 below:

TABLE 6

| RPN | FREQUENCY | ADJUSTMENT TO FREQUENCY |
|---|---|---|
| Low | Weekly | Decrease to two (2) weeks |
| Low | Monthly | Decrease to two (2) months |
| Low | Quarterly | Decrease to half year |
| Low | Semi-annually | Decrease to annual |
| Medium | Weekly | Decrease to two (2) weeks |
| Medium | Monthly | Decrease to six (6) weeks |
| Medium | Quarterly | Decrease to 18 weeks |
| Medium | Semi-annually | Decrease to 24 weeks |
| High | ALL | No change unless failure recovery plan |

If the statistical analysis reveals that failures have indeed occurred between procedures or activities associated with the PM code (no branch of 138), then the PM frequency is a prime candidate for increase. In this situation, regression equation 102 (FIG. 8) calculated from the coded historical data can be applied to calculate the frequency adjustment (144). Specifically, if the regression equation indicates a correlation 104 (FIG. 8) of 70% or greater, then a strong statistical correlation exists between PM frequency and the number of failures between performance of the respective PM procedure or activity. As a result, a new maintenance frequency can be calculated using the regression formula.

In general, the regression formula can be written for the selected PM code as follows:

Failures=C+F*MTBPM, (2)

where C and F are constants calculated by the regression analysis, and MTBPM represents the mean time between performance of the procedure or activity associated with the PM code, as described above. From equation 2, a current maintenance hours/day (AM_{C}) can be calculated as follows:

AM_{C}=APM_{C}+AR_{C}, (3)

where current average repair hours per day for the current frequency can be calculated as:

AR_{C}=[Failures(current PM interval)*MTTR]/MTBPM(current PM interval), (4)

where MTTR equals the mean time to repair, as described above. The current average PM hours per day can be calculated as follows:

APM_{C}=MTTE−PM/MTBPM(current PM interval), (5)

where MTTE-PM represents the mean time to execute the procedure or activity associated with the PM code, as described above. A proposed MTBPM can be selected, and a proposed maintenance hours per day (AM_{P}) can be calculated by:

AM_{P}=APM_{P}+AR_{P} (6)

where proposed average repair hours per day for the current frequency can be calculated using the regression formula as:

AR_{P}=[Failures(proposed PM interval)*MTTR]/MTBPM(proposed PM interval). (7)

The proposed average PM hours per day can be calculated as follows:

APM_{P}=MTTE−PM/MTBPM(proposed PM interval). (8)

Finally, a proposed PM frequency (PM_Freq_{P}) can be selected. In particular, PM_Freq_{P}, can be selected from actual values produced by the regression analysis, e.g., values within the 95% confidence limits. The proposed PM frequency is substituted for the current PM frequency, thereby increasing the frequency, i.e., decreasing the interval between procedures or activities, based on the statistical correlation between the current PM frequency and the number of failures that occurred between procedures or activities associated with the current PM code.

For example, assume the regression analysis results in the following equation:

Failures=−24.87+1.48*PM interval, (9)

and MTTE-PM equals 4.3 hours, MTTR equals 2.2 hours, and MTBPM is currently 28 days. In this example, the regression analysis can be used to compute a total maintenance time for the current PM frequency. In particular, using regression equation (9), the number of failures can be statistically computed as 1.48*28−24.87=16.6 failures. A total repair hours for the failures per maintenance interval can be computed as 16.6 failures*2.2 hours per failure=36.5 hours. A total maintenance time per day can then be calculated as (36.5 hours+4.3 hours)/28 days=1.5 hours per day.

Assuming a proposed PM interval of 21 days is selected from the regression chart, a total maintenance time for the proposed maintenance interval can be computed in similar fashion. Using regression equation (9) the number of failures for the proposed PM interval can be statistically computed as 1.48*21−24.87=6.2 failures. A total repair hours for the failures per maintenance period can be computed as 6.2 failures*2.2 hours per failure=13.7 hours. A total maintenance time per day can then be calculated as (13.7 hours+4.3 hours)/21 days=0.86 hours per day, which represents a 43% potential reduction in overall maintenance time.

This process is repeated for all of the PM codes (150). In this manner, the effectiveness of preventive maintenance procedures in detecting and reducing equipment failures can be improved. Moreover, the PM frequencies associated with PM procedures or activities can be statistically controlled using historical data. Consequently, opportunities for increasing PM frequencies to reduce failures, as well as opportunities to decrease PM frequencies to achieve cost saving without increasing equipment failure, can be statistically identified and evaluated.

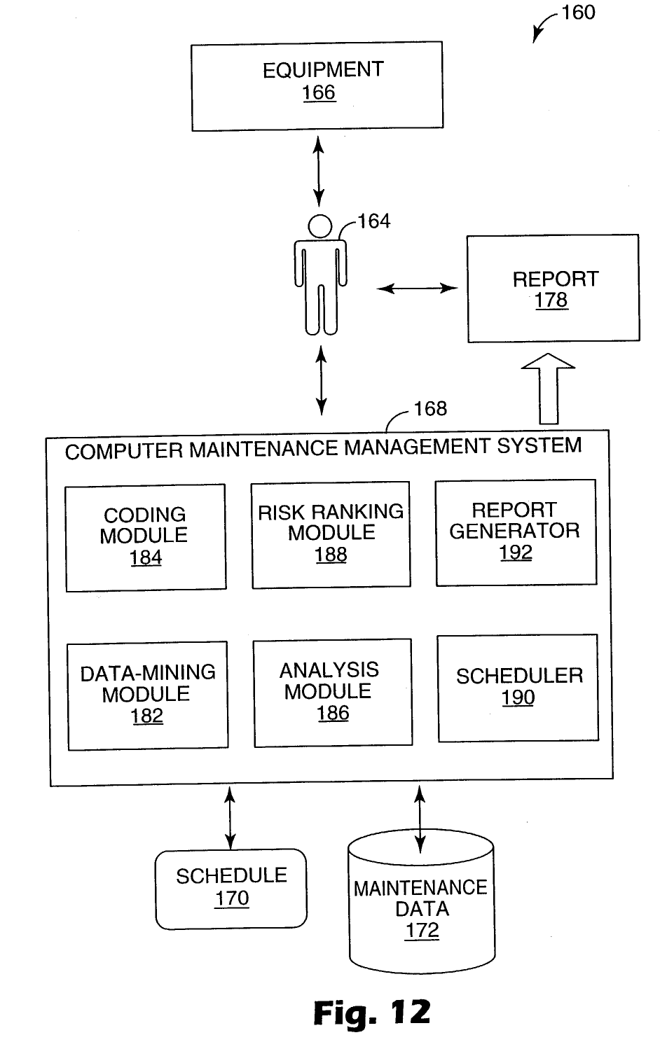

FIG. 12 is a block diagram of an exemplary system 160 for statistically controlling frequencies of preventive maintenance (PM) procedures in a more automated fashion. In particular, in the example of FIG. 12, many of the functions described above have been integrated into computer maintenance management system (CMMS) 168.

As described in reference to system 2 of FIG. 1, a technician 164 provides maintenance services for equipment 166 including preventive maintenance (PM) procedures and unplanned maintenance procedures, such as corrective or emergency maintenance procedures, in the event of a failure of equipment 166. Technician 164 performs PM procedures in accordance with a schedule 170 maintained by a scheduler 190 of computerized maintenance managements system (CMMS) 168. CMMS 168 maintains maintenance data 172 that describes pending and completed shop work orders (SWOs) for maintenance procedures performed or to be performed on equipment 166. CMMS 168 may maintain maintenance data 172 as any of a variety of data structures, including one or more files or a database, such as a relational database.

In this embodiment, CMMS 168 includes a data-mining module 182, a coding module 184, an analysis module 186, a risk ranking module 188, a scheduler 190, and a report generator 192. Each of these modules represent software, firmware, hardware, or combinations thereof, for performing the described techniques. For example, CMMS 168 may comprise one or more computers having one or more programmable processors to execute machine instructions for performing the described functions. The instructions may be stored in a computer-readable medium, such as a hard disk, a removable storage medium, read-only memory, random access memory, Flash memory, or the like.

Coding module 184 maintains a coding scheme that assigns a unique PM code to each of the defined PM procedures performed on equipment 166. Coding module 184 presents a user interface by which technician 164 may define the coding scheme, and map the unique codes to PM procedures or activities. In this manner, technician 164 may designate the PM coding scheme in any manner that supports correlation of failures to PM procedures or activities designed to detect, prevent or eliminate those failures.

As technician 164 interacts with CMMS 168 to enter shop work orders (SWOs), coding module 184 presents a user interface having an input area, e.g., a drop down box, by which the technician selects PM codes to map the shop work orders to identifiers associated with the preventive maintenance procedure. In this manner, CMMS 168 facilitates the automatic coding of SWOs, i.e., a mapping between the SWOs and identifiers associated with the PM procedures, as the SWOs are created.

Data-mining module 182 interacts with CMMS 168, e.g., periodically, to extract all or a portion of the SWO records maintained by maintenance data 172 for a previous period, e.g., one year. In particular, data-mining module 182 extracts SWO records that describe the non-planned maintenance procedures, e.g., EM and CM procedures, as well as each PM procedure performed on equipment 166.

In analysis module 186, technician 164 automatically employs the statistical analysis techniques described herein to analyze the SWO records extracted by data-mining module 182 to generate statistical data. For example, as described above, analysis module 186 automatically calculates frequencies for each failure associated with each PM code, the cost associated with conducting each PM procedure or activity mapped to each PM code, a mean time between PM procedures, statistical variability for the computed frequencies of the PM procedures or activities for the PM codes, regression analysis to correlate PM frequency to the number of failures between procedures, mean time between failures, and any statistical variability in repair hours for emergency type SWOs.

Scheduler 190 makes use of the statistical data to automatically adjust PM frequencies, e.g., by applying the equations described above to compute a new PM frequency. During this process, scheduler 190 may invoke risk ranking module 188 to evaluate a level of risk that may be associated with the related failures to aid in determining whether and to what extent to automatically adjust the frequencies.

Report generator 192 produces analysis report 178 that includes the statistical data generated by analysis module 186, and the updated PM frequencies computed by scheduler 190. In addition, scheduler 190 automatically updates schedule 170 based on the updated PM frequencies. In this manner, CMMS 168 provides automated statistical control over the frequencies of the PM procedures performed by technician 164.

Various embodiments of the invention have been described. These and other embodiments are within the scope of the following claims.

1. A method comprising:
analyzing maintenance data to identify preventive maintenance procedures and unplanned maintenance procedures performed on equipment;
mapping the unplanned maintenance procedures to identifiers associated with the preventive maintenance procedures;
determining whether statistical correlations exist between the preventive maintenance procedures and the unplanned maintenance procedures based on the mapping; and
updating a schedule for performing the preventive maintenance procedures based on the determination.

2. The method of claim 1, wherein updating a schedule comprises updating frequencies for performing the preventive maintenance procedures when confidence levels for the statistical correlations exceed a threshold.

3. The method of claim 1, wherein updating a schedule comprises increasing frequencies for performing the preventive maintenance procedures that are mapped to one or more respective unplanned maintenance procedures.

4. The method of claim 1, wherein updating a schedule comprises decreasing frequencies for performing at least a subset of the preventive maintenance procedures based on the determination.

5. The method of claim 4, wherein decreasing the frequencies comprises decreasing frequencies for performing the preventive maintenance procedures that are mapped to less than a threshold number of unplanned maintenance procedures.

6. The method of claim 1, wherein updating the schedule comprises:
statistically calculating a risk value associated with each of the preventive maintenance procedures; and
determining adjustments for the preventive maintenance procedures as a function of the respective calculated risk values.

7. The method of claim 6, wherein statistically calculating a risk value comprises calculating a risk priority number for each of the preventive maintenance procedures.

8. The method of claim 1, wherein updating a schedule comprises:
computing a mean time between failure for each identifier based on the unplanned maintenance procedures associated with the identifiers; and
determining adjustments for the schedule as a function of the calculated mean time between failures.

9. The method of claim 1, further comprising extracting the maintenance data from a computer maintenance management system.

10. The method of claim 1, wherein the maintenance data comprises shop work order records, and mapping the unplanned maintenance procedures to identifiers comprises:
examining the shop work order records to identify the shop work orders for the unplanned maintenance procedures that serviced failures of the equipment; and
associating the identified shop work orders with the identifiers associated with preventive maintenance procedures designed to detect or prevent the failures.

11. The method of claim 1, wherein each of the preventive maintenance procedures includes one or more activities, and mapping the unplanned maintenance procedures comprises:
defining identifiers for the activities of the preventive maintenance procedures; and
mapping the unplanned maintenance procedures to identifiers associated with the activities.

12. The method of claim 1, further comprising:
performing pattern analysis on the maintenance data based on the mapping to identify trends within the preventive maintenance procedures and the unplanned maintenance procedures; and
updating the schedule for performing the preventive maintenance procedures based on the trend analysis.

13. The method of claim 1, wherein determining whether statistical correlations exist comprises computing a statistical variance in actual frequencies for the preventive maintenance procedures associated with each of the identifiers, and wherein updating a schedule comprises updating the schedule for the preventive maintenance procedures based on the computed statistical variances of the actual frequencies.

14. The method of claim 13, wherein determining whether statistical correlations exist comprises performing regression analyses on the computed statistical variances to compute the correlations between the actual frequencies and the unplanned maintenance procedures.

15. The method of claim 1, further comprising independently statistically analyzing the maintenance data based on the mapping to compute a respective regression equation for each identifier.

16. The method of claim 1, wherein mapping the unplanned maintenance procedures comprises presenting a user interface of a computer maintenance management system to receive input that maps the unplanned maintenance procedures to the identifiers.

17. The method of claim 1, further comprising invoking a computer maintenance management system to automatically analyze the maintenance data and update the schedule.

18. The method of claim 1, wherein the unplanned maintenance procedures comprise emergency maintenance procedures and corrective maintenance procedures.

19. A method comprising:
generating one or more correlation equations from maintenance data that specifies preventive maintenance procedures and unplanned maintenance procedures performed on equipment; and
outputting a schedule for performing the preventive maintenance procedures based on the correlation equations.

20. The method of claim 19, further comprising performing the preventive maintenance procedures on the equipment in accordance with the schedule.

21. The method of claim 19, further comprising:
mapping the unplanned maintenance procedures to identifiers associated with the preventive maintenance procedures; and
statistically analyzing the maintenance data to generate one of the correlation equations for each of the identifiers based on the mapping.

22. The method of claim 21, wherein outputting a schedule comprises:
computing a mean time between failure for each identifier based on the unplanned maintenance procedures associated with the identifiers; and
determining adjustments for the frequencies as a function of the calculated mean time between failures.

23. The method of claim 19, wherein outputting a schedule comprises:
statistically calculating a risk value associated with each of the preventive maintenance procedures; and
determining adjustments for the preventive maintenance procedures as a function of the respective calculated risk values.

24. A method comprising:
presenting an interface to receive maintenance data that define shop work orders for preventive maintenance procedures and unplanned maintenance procedures for equipment, wherein the interface includes an input area to map the shop work orders to identifiers associated with the preventive maintenance procedures;
automatically analyzing the maintenance data in accordance with the mapping to determine whether statistical correlations exist between the preventive maintenance procedures and the unplanned maintenance procedures; and
automatically updating frequencies associated with the preventive maintenance procedures based on the determination.

25. The method of claim 24, further comprising outputting a schedule in accordance with the updated frequencies.

26. The method of claim 24, wherein updating the frequencies comprises decreasing the frequencies for at least a subset of the preventive maintenance procedures based on the determination.

27. A computer-readable medium comprising instructions for causing a processor to:
present an interface to receive maintenance data that define shop work orders for preventive maintenance procedures and unplanned maintenance procedures for equipment, wherein the interface includes an input area to map the shop work orders to identifiers associated with the preventive maintenance procedures;
automatically analyze the maintenance data in accordance with the mapping to determine whether statistical correlations exist between the preventive maintenance procedures and the unplanned maintenance procedures; and
automatically update frequencies associated with the preventive maintenance procedures based on the determination.

28. The computer-readable medium of claim 27, further comprising instructions to cause the processor to output a schedule in accordance with the updated frequencies.

29. The computer-readable medium of claim 27, wherein the instructions cause the processor to update the frequencies when confidence levels for the statistical correlations exceed a threshold.

30. The computer-readable medium of claim 27, wherein the instructions cause the processor to increase the frequencies for the preventive maintenance procedures associated with identifiers that are mapped to one or more unplanned maintenance procedures.

31. The computer-readable medium of claim 27, wherein the instructions cause the processor to decrease the frequencies for at least a subset of the preventive maintenance procedures based on the determination.

32. The computer-readable medium of claim 27, wherein the instructions cause the processor to decrease the frequencies of the preventive maintenance procedures associated with identifiers that are mapped to less than a threshold number of unplanned maintenance procedures.

33. The computer-readable medium of claim 27, wherein the instructions cause the processor to statistically calculate a risk value associated with each of the frequencies, and determine adjustments for the frequencies as a function of the respective calculated risk values.

34. The computer-readable medium of claim 33, wherein the instructions cause the processor to calculate the risk values as risk priority numbers.

35. The computer-readable medium of claim 27, wherein the instructions cause the processor to compute a mean time between failure for each identifier based on the unplanned maintenance procedures associated with the identifiers, and determine adjustments for the frequencies as a function of the calculated mean time between failures.

36. The computer-readable medium of claim 27, wherein the instructions cause the processor to extract the maintenance data from a computer maintenance management system.

37. The computer-readable medium of claim 27, wherein the instructions cause the processor to compute a statistical variance in actual frequencies for the preventive maintenance procedures associated with each of the identifiers, and update the frequencies for the preventive maintenance procedures based on the computed variances of the actual frequencies.

38. The computer-readable medium of claim 27, wherein the instructions cause the processor to perform regression analysis based on the computed statistical variances to determine whether correlations exist between the actual frequencies and the unplanned maintenance procedures.

39. A system comprising:
a database that stores maintenance data that describes preventive maintenance procedures and unplanned maintenance procedures performed on equipment;
a scheduler that generates a schedule for the preventive maintenance procedures in accordance with respective frequencies; and
a statistical analysis module that analyzes the maintenance data and computes updated frequencies for the preventive maintenance procedures.

40. The system of claim 39, wherein the statistical analysis module computes the updated frequencies based on statistical correlations between the preventive maintenance procedures and the unplanned maintenance procedures.

41. The system of claim 40, wherein the statistical analysis module computes the updated frequencies when confidence levels for the statistical correlations exceed a threshold.

42. The system of claim 39, further comprising a data mining module that extracts shop work orders from the database that describe the preventive maintenance procedures and the unplanned maintenance procedures.

43. The system of claim 39, further comprising a coding module that maps the unplanned maintenance procedures to identifiers associated with the preventive maintenance procedures.

44. The system of claim 42, wherein the statistical analysis module increases the frequencies for the preventive maintenance procedures associated with identifiers that are mapped to one or more unplanned maintenance procedures.

45. The system of claim 42, wherein the statistical analysis module decreases the frequencies of the preventive maintenance procedures associated with identifiers that are mapped to less than a threshold number of unplanned maintenance procedures.

46. The system of claim 42, wherein the statistical analysis module computes a mean time between failure for each identifier based on the unplanned maintenance procedures associated with the identifiers, and determines adjustments for the frequencies as a function of the calculated mean time between failures.

47. The system of claim 39, wherein the statistical analysis module decreases the frequencies for at least a subset of the preventive maintenance procedures.

48. The system of claim 39, wherein the statistical analysis module calculates a risk value associated with each of the frequencies, and determines adjustments for the frequencies as a function of the respective calculated risk values.

49. The system of claim 48, wherein the statistical analysis module calculates the risk values as risk priority numbers.

50. The system of claim 39, wherein the statistical analysis module computes a statistical variance in actual frequencies for the preventive maintenance procedures, and updates the frequencies for the preventive maintenance procedures based on the computed variances of the actual frequencies.

51. The system of claim 50, wherein the statistical analysis module performs regression analyses based on the computed statistical variances to determine whether correlations exist between the actual frequencies and the unplanned maintenance procedures.
